(19) United States
(12) Patent Application Publication
(10) Pub. No.: US 2011/0171970 A1
(43) Pub. Date: Jul. 14, 2011

(54) MOBILE STATION POSITION LOCATING SYSTEM

(75) Inventor: KAN ISHIKAWA, Toyoake (JP)

(73) Assignee: BROTHER KOGYO KABUSHIKI KAISHA, Nagoya (JP)

(21) Appl. No.: 13/070,672

(22) Filed: Mar. 24, 2011

Related U.S. Application Data
(63) Continuation-in-part of application No. PCT/JP2009/056008, filed on Mar. 25, 2009.

(30) Foreign Application Priority Data
Sep. 26, 2008 (JP) 2008-249228

(51) Int. Cl. H04W 24/00

(52) U.S. Cl. 455/456.1

(57) ABSTRACT

A mobile station position locating system, having a mobile station and a plurality of base stations is disclosed. The mobile station is configured to transmit a position location signal. The plurality of base stations is configured to receive the position location signal and includes: a reference base station for transmitting predetermined spread codes several times as time adjustment signals; and an ordinary base station for receiving the time adjustment signals. The mobile station position locating system includes a reception time correcting section for correcting a reception time of the position location signal and a position locating section for determining a position of the mobile station. The mobile station and the reference base station being responsive to one of transmission of the position location signal from the mobile station and transmission of the time adjustment signal from the reference base station for executing the other one of the transmissions.

### CROSS REFERENCE TO RELATED APPLICATION

The present application is a Continuation-in-Part of International Application No. PCT/JP2009/056008 filed Mar. 25, 2009, which claims the benefits of Japanese Patent Application No. 2008-249228 filed Sep. 26, 2008, the disclosure of which is herein incorporated by reference in its entirety.

### FIELD OF THE DISCLOSURE

This invention relates to a mobile station position locating system in which a radio wave, transmitted from a mobile station, is received at a plurality of base stations with a reception result, including a time deviation between reception times in the respective base stations, based on which a position of the mobile station is estimated.

### BACKGROUND

A position locating system and a position locating method have heretofore been proposed in the art in which a radio wave, transmitted from a mobile station, is received at a plurality of base stations with a resultant time difference between the reception times in the plurality of respective base stations based on which the position of the mobile station is detected.

With such a position locating system or a position locating method, a need arises to determine a time difference occurring when the plurality of base stations receives the radio wave. Thus, respective timers of the plurality of base stations need to be adjusted in common time.

Meanwhile, a technology has been proposed to correct based on tendencies of the respective timers of the plurality of base stations in advance instead of adjusting times in the respective timers of the plurality of base stations. As used herein, the term “tendency of the timer” refers to, for instance, a clock rate ratio or a time deviation or the like of the timers. These tendencies of the timers can be grasped upon performing the detection or the calculation.

For instance, a technology as described below is known. One base station transmits signals several times which are received by a plurality of other base stations at reception times that are measured in terms of respective clocks of the other base stations. Then, the plurality of other base stations estimates a ratio (clock rate ratio) of clock rates of the respective base stations based on the reception times or the like. The plurality of other base stations corrects the reception times of the respective base stations for the radio wave received from the mobile station based on an estimated clock rate ratio for thereby detecting the position of the mobile station.

### SUMMARY OF THE INVENTION

With hardware in actual practice, meanwhile, limited accuracies exist in controlling a transmission interval of signals in wireless communication and detecting a reception interval of the same. When an attempt is made to improve accuracy of detecting the clock rate ratio under a situation of limited accuracies in controlling the transmission interval and detecting the reception interval, a problem is how to eliminate an adverse affect on the clock rate ratio due to accuracies in control of the transmission interval and measurement of the reception interval.

With hardware in actual practice, further, there exists a time lag (delay time) inherent to equipment. When a transmission command for a radio wave is sent from, for example, a microcomputer or the like during transmission of the radio wave, therefore, the radio wave is transmitted after an elapse of a time equivalent to the time delay inherent to a transmission circuit or the like. In reception of the radio wave, likewise, a reception time is obtained after the radio wave is actually received and, further, a time equivalent to a time delay inherent to a receiver circuit or the like elapses. When calculating a position of the mobile station based on such a reception time of the radio wave transmitted from the mobile station or for the purpose of accurately calculating the clock rate ratio, such time delays need to be taken into account.

Aspects of the present disclosure provide a mobile station position locating system wherein even when a time deviation or a difference in clock rates are present in timers of the respective base stations and, further, a transmission delay time and a reception delay time inherent to equipment are present, a position of a mobile station can be accurately determined by taking into account the time deviation and the clock rate ratio.

According to an aspect of the present disclosure, a mobile station position locating system may have a mobile station configured to transmit a position location signal; and a plurality of base stations configured to receive the position location signal transmitted from the mobile station, wherein: the plurality of base stations comprises: a reference base station configured to transmit predetermined spread codes several times as time adjustment signals; and an ordinary base station configured to receive the time adjustment signals transmitted from the reference base station; and the mobile station position locating system comprising: a reception time correcting section configured to correct a reception time of the position location signal, determined by the ordinary base station based on a timer thereof, to a time based on a timer of the reference base station in response to: a clock rate ratio between a clock rate of the ordinary base station, determined for each of the ordinary base station based on a result in which the time adjustment signals are received by the ordinary base station and a result in which the time adjustment signals are transmitted from the reference base station, and a clock rate of the reference base station; a time deviation between the time of the timer of the ordinary base station, determined for each of the ordinary base station, and the time of the timer of the reference base station; and a transmission delay time and a reception delay time in the reference base station; and a position locating section configured to determine a position of the mobile station based on: the reception time of the position location signal in the ordinary base station which is corrected by the reception time correcting section; the reception time of the position location signal in the reference base station; and positional information on the ordinary base station and the reference base station; and the mobile station and the reference base station are configured to be responsive to one of transmission of the position location signal from the mobile station and transmission of the time adjustment signal from the reference base station for executing the other one of the transmissions.

### BRIEF DESCRIPTION OF THE DRAWINGS

FIG. 1 is a view illustrating an outline of a structure of a mobile station position locating system of one illustrative embodiment.

FIG. 2 is a functional block diagram illustrating an outline of a function of a mobile station forming the mobile station position locating system shown in FIG. 1.

FIG. 3 is a functional block diagram illustrating an outline of a function of an ordinary base station forming the mobile station position locating system shown in FIG. 1.

FIG. 4 is a functional block diagram illustrating an outline of a function of a reference base station forming the mobile station position locating system shown in FIG. 1.

FIG. 5 is a functional block diagram illustrating an outline of a function of a position locating server forming the mobile station position locating system shown in FIG. 1.

FIG. 6 is a view illustrating one example of a structure of a matched filter incorporated in a reception time detecting sections of the reference base station and the ordinary base station.

FIG. 7 is a view illustrating the relationship between an elapsed the time from a rise in the base station and a reception delay time.

FIG. 8 is a view illustrating a position locating principle of a position locating section of the position locating server.

FIG. 9 is a timeline diagram representing the relationship among various variables in a position locating process.

FIG. 10 is a flowchart illustrating an outline of control operations executed in the mobile station position locating system shown in FIG. 1.

FIG. 11 is a flowchart illustrating an outline of control operations, among the control operations in FIG. 10, which are related to transmission and reception of a radio wave in the reference base station.

FIG. 12 is a flowchart illustrating predetermined time alteration routine (SA19) in the position locating server in FIG. 10.

FIG. 13 is a view showing definitions of various variables used in FIG. 9.

### DETAILED DESCRIPTION

Now, one illustrative embodiment of the present invention will be described below in detail with reference to the accompanying drawings.

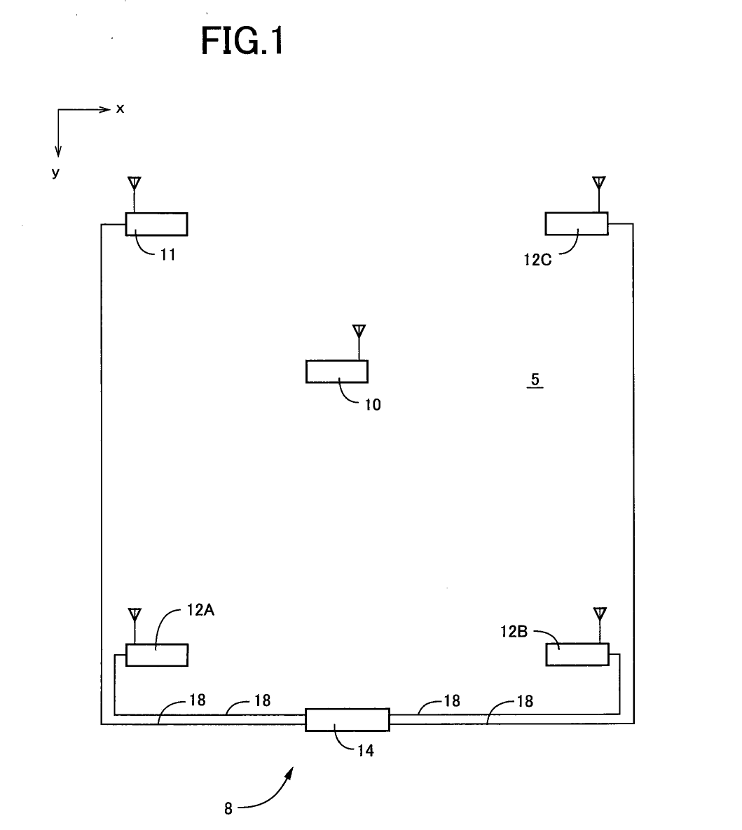

FIG. 1 is a view illustrating an outline of a structure of a mobile station position locating system 8. As shown in FIG. 1, the position locating system 8 includes: a mobile station 10 moveable in a predetermined area 5; a reference base station 11 fixed in place on a known position and having a function to perform wireless communication with the mobile station 10; four base stations 12 (hereinafter referred to as “ordinary base stations 12” when no discrimination is made among first to third base stations 12A to 12C and, further, referred to as “base stations 11 and 12” when no discrimination is made among the reference base station 11 and the first to third base stations 12A to 12C) including the reference base station 11 and the first to third base stations 12A to 12C; and a server 14 comprised of a so-called microcomputer including, for instance, a CPU, a RAM, a ROM and input/output interfaces, etc. Also, the present invention is not limited to the number of mobile stations 10 provided that the number of mobile stations 10 includes one or more pieces. In addition, the base stations 11 and 12 and the server 14 are enabled to perform communication with each other over a LAN. When this takes place, if the LAN is wired, then, the base stations 11 and 12 and the server 14 are connected to each other by means of communication cables 18.

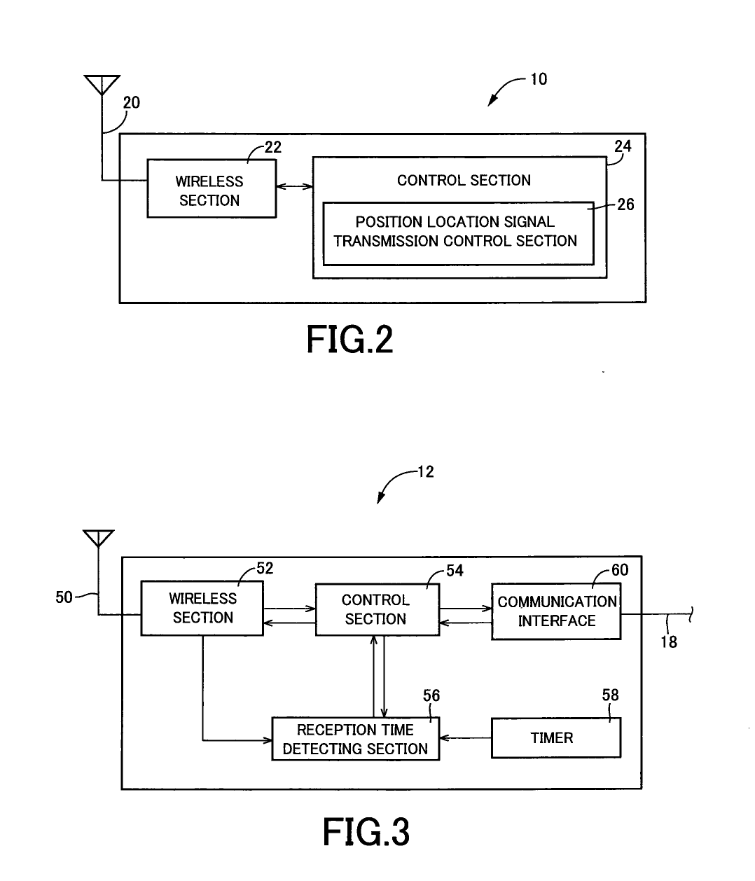

FIG. 2 is a functional block diagram for illustrating an essential part of a function of the mobile station 10. The mobile station 10 includes an antenna 20, a wireless section 22 and a control section 24, etc. In addition, the mobile station 10 includes a so-called microcomputer comprised of, for instance, a CPU, a RAM, a ROM and input/output interfaces, etc. The CPU performs signal processing in accordance with programs preliminarily stored in the ROM while utilizing a temporary storage function of the RAM, thereby executing the processing such as in the wireless section 22.

The wireless section 22 is of the type that realizes a so-called wireless communication function to send or receive radio waves using the antenna 20. For instance, the wireless section 22 transmits a radio wave, containing a spread code for a correlation value to be calculated, to the base stations 11 and 12. Further, the wireless section 22 receives radio waves, including commands related to operations of the mobile station 10, which are transmitted from the base stations 11 and 12. The wireless section 22 includes an oscillator for generating a carrier wave at a predetermined frequency, a modulator for modulating the carrier wave and performing digital modulation or the like based on signals transmitted in terms of the radio waves, and a transmission amplifier for amplifying the modulated carrier wave at a predetermined output. Moreover, the wireless section 22 has a receiving function that can be realized by a reception amplifier for amplifying a received wave received at the antenna 20, a filter for extracting only a predetermined frequency component from the received wave, and a demodulator for performing demodulation such as a digital demodulator or a wave detector. When this takes place, the wireless communication, performed by the wireless section 22, preferably employs, for instance, so-called digital communication and, hence, the wireless section 22 includes a mechanism for modulation or demodulation required for relevant digital communication.

Further, the antenna 20 is of the type, used when the wireless section 22 transmits or receives the radio waves, which includes those of frequencies suited for transmission and reception of the radio waves. In addition, the antenna 20 may preferably include an antenna that is omnidirectional in at least a direction in propagation of the radio wave such that: when placed away from the mobile station 10 in the same distance, the base stations 11 and 12, spaced from the antenna 20 in an equal distance, can receive the radio wave with equal intensity regardless of the direction of the mobile station 10.

The control section 24 performs controls of the wireless section 22. The control section 24 performs the switching of the wireless section 22 for transmission or reception of the radio wave, the setting of carrier wave frequencies and the setting of the transmission amplifier. Setup values for such controls are determined based on results in communication between the base stations 11 and 12. Further, the control section 24 analyzes contents of the radio waves, delivered from the base stations 11 and 12 and received by the wireless section 22 for demodulation, for extracting commands related to control operations of the mobile station 10. Moreover, the control section 24 generates a spread code to be transmitted from the mobile station 10 over the radio wave.

Further, the control section 24 functionally includes a position location signal transmission control section 26. The position location signal transmission control section 26 allows the wireless section 22 to transmit a position location signal in the form of a signal including the spread code for locating the position depending on the commands from the base stations 11 and 12. The spread code, contained in such a position location signal, includes, for instance, so-called PN (pseudo noise) codes in the form of codes of the kind preliminarily stored in the control section 24 of the mobile station 10 and a control section 34 of the reference base station 11 or a control section 54 of the ordinary base station 12 in common which will be described below. More particularly, for instance, a plurality of kinds of codes is preliminarily stored in the mobile station 10 and the base stations 11 and 12 in common to allow the mobile station 10 and the base stations 11 and 12 to exchange information on which of the codes is to be transmitted after which the position location signal transmission control section 26 transmits a determined code.

FIG. 3 is a functional block diagram for illustrating an essential part of the function of the ordinary base station 12. The ordinary base station 12 includes an antenna 50, a wireless section 52, a reception time detecting section 56, a timer 58, and communication interface 60 and a control section 54, etc. Further, the base station 12 is comprised of a so-called microcomputer including, for instance, a CPU, a RAM, a ROM and input and output interfaces or the like. By executing signal processing in accordance with programs preliminarily stored in the ROM by using a temporary storage function of the RAM, the CPU performs processing such as in the reception time detecting section 56 and the wireless section 52.

The wireless section 52, realizing a so-called wireless communicating function, performs transmission and reception of the radio wave with the use of the antenna 50. The wireless section 52 transmits a radio wave containing a command for controlling the operation of the mobile station 10. Meanwhile, the wireless section 52 receives the radio wave, transmitted from the mobile station 10, the content of which is delivered to the reception time detecting section 56 or the like for processing to be executed depending on needs. That is, the wireless section 52 includes: an oscillator for generating a carrier wave at a predetermined frequency; a modulator for modulating the carrier wave based on a signal transmitted with the radio wave or performing digital modulation thereof; and a transmission amplifier for amplifying the modulated carrier wave into a predetermined output. The wireless section 52 further includes: a reception amplifier for amplifying a received wave received at the antenna 50; a filter for extracting only a predetermined frequency component from the received wave; and a demodulator or the like for performing demodulation such as a digital demodulator and a wave detector or the like. When this takes place, the wireless communication, performed by the wireless section 52, preferably includes, for instance, so-called digital communication and, hence, the wireless section 52 includes a mechanism for performing modulation or demodulation required for such digital communication.

Further, the antenna 50, used for the wireless section 52 to perform transmission and reception of the radio wave, may include those suited for the frequency of the radio wave to be transmitted or received. Moreover, examples of the antenna 50 may preferably include an antenna that is omnidirectional in respect of at least a propagating direction of the radio wave. This enables the antenna 50 to receive the radio wave with the same intensity regardless of a position of the mobile station 10, viz., when the mobile station 10 is present in a position spaced from the base stations 12 by an equal distance regardless of a direction of the mobile station 10 as viewed from the base stations 12.

The control section 54 serves to control the wireless section 52 and the reception time detecting section 56. The control section 54 performs the switching of the wireless section 52 for transmission or reception of the radio wave, the setting of carrier wave frequencies, and the setting of a transmission amplifier, etc. Setup values for these controls are determined based on results in communication between a position locating server 14, described below, and the mobile station 10. Further, the control section 54 controls the reception time detecting section 56 for execution of reception time detection and controls a request and acquisition of a reception time detection result. In addition, the control section 54 analyzes the contents of the radio wave, transmitted from the mobile station 10, which is received and demodulated by the wireless section 52. Likewise, the control section 54 analyzes a transmitted content, delivered from the position locating server 14 and received via a communication interface 60, described below, for extracting commands related to control operations of the base stations 12. Beside, the control section 54 generates control commands related to the mobile station 10 for the operation.

Further, the reception time detecting section 56 calculates a correlation value between the spread code, contained in the radio wave transmitted from the mobile station 10, and a replica code representing the same code as the spread code. More particularly, as set forth above, such a correlation value can be obtained by: preparing a common code for the mobile station 10 and the base stations 11 and 12; and preliminarily inputting a replica code, identical to the spread code which the mobile station 10 transmits, and the spread code (received code), extracted from the radio wave received from the mobile station 10, into a matched filter. This enables the correlation value between both codes to be obtained. A time, representing a peak of the correlation value obtained in such a way, corresponds to the reception time of the radio wave. Accordingly, acquiring the time, at which the peak of the correlation value is detected in the reception time detecting section 56 by referring to a timer 58, described later, results in detection of the reception time of the spread code.

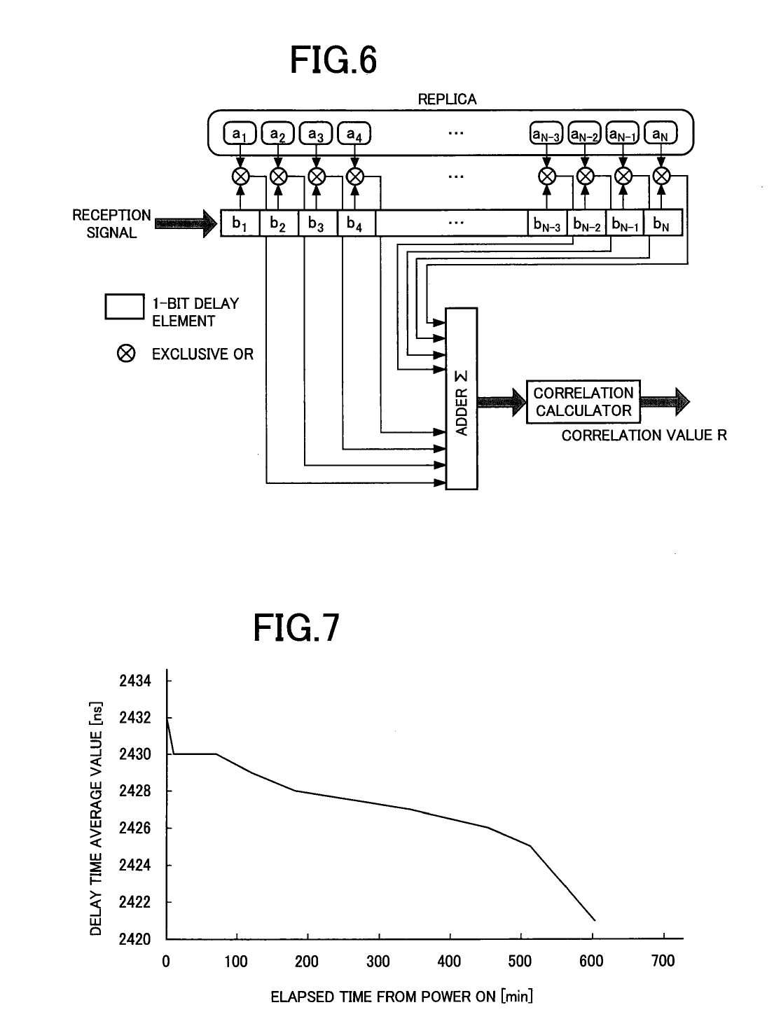

FIG. 6 is a view showing an example of a structure of the matched filter incorporated in the reception time detecting section 56. The matched filter calculates values of an exclusive OR of the spread code (received signal) “b”, received by the wireless section 52, and the replica code “a” for bits thereof, upon which the values of the exclusive OR are added up in an adder Σ upon which a correlation calculator calculates a correlation value “Rab” (l) between the replica code “a” and the spread code “b” as expressed by:

$${R}_{ab} ( l ) = N - {\sum }_{k = 1}^{N} {a}_{k} ⊕ {b}_{k + 1} \qquad ( 1 )$$

where “ai” and “bi” (i=1, . . . , N) represent contents of the replica code “a” and the spread code “b” on the i-th bit, respectively. As shown in FIG. 6, further, the received signal “b” is arranged to shift by one bit each the time the correlation value “Rab” is calculated by a one-bit deviation element and “l” in Equation (1) represents a total sum of the amount of such shift. Such calculation results in a capability of calculating the time, at which a peak of the correlation value “Rab” occurs, based on such as a value of “l” and a reception speed appearing when the peak of the correlation value “Rab” occurs. The time, at which the peak of the correlation value calculated in such a way, is assigned to be a reception time.

Turning back to FIG. 3, the timer 58 serves to measure the time and will be referred to when, for instance, the reception time detecting section 56 detects the reception time.

The communication interface 60 performs information communication between the base stations 11 and 12 and the position locating server 14. In the illustrated embodiment, although the base stations 11 and 12 and the position locating server 14 are connected to each other via the cable 18 for communication, the present invention is not limited to such a wired communication but may execute wireless communication through the use of such as a so-called wireless LAN. In particular, the reception time of the radio wave, detected by the reception time detecting section 56 of the base station 12, and information contained in the radio wave transmitted from the mobile station 10 are transmitted from the base stations 12 to the server 14. In addition, the server 14 transmits such as a command, related to the operation of the mobile station 10, to the base stations 12.

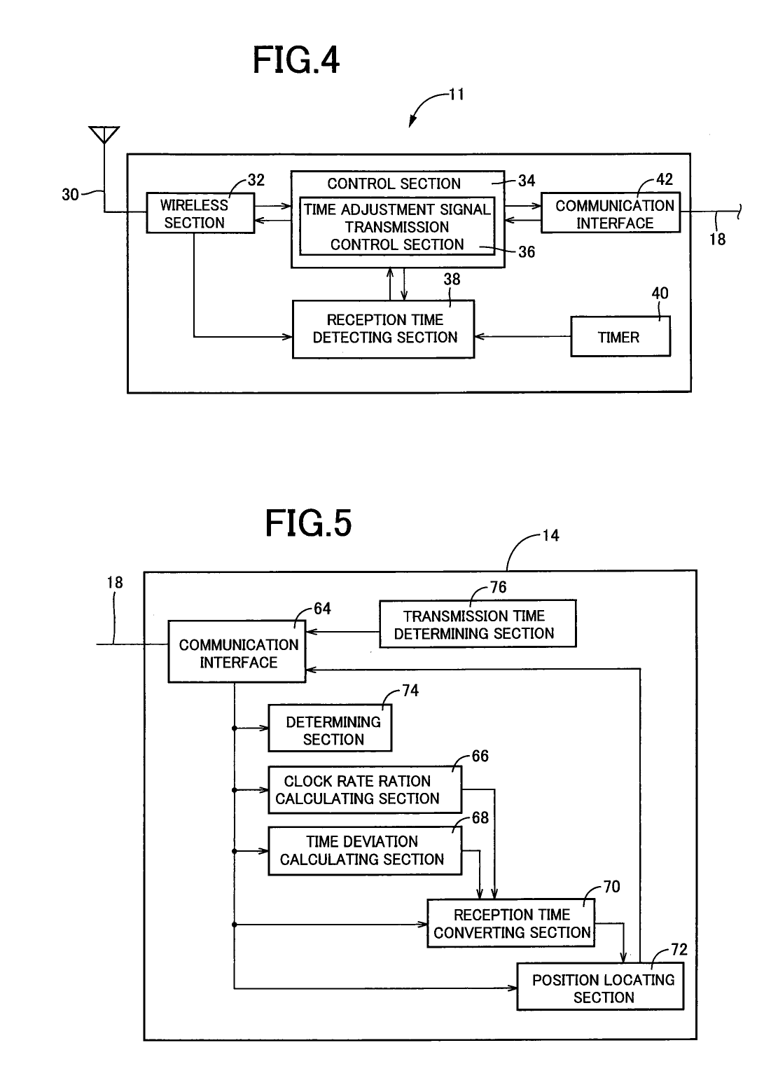

FIG. 4 is a functional block diagram for illustrating an essential part of the function of the reference base station 11. The reference base station 11, having the nearly same functional structure as that of the ordinary base station 12 shown in FIG. 3, includes an antenna 30 of the reference base station 11, a wireless section 32, a control section 34, a reception time detecting section 38, a timer 40 and a communication interface 42: which have the same functions as those of the antenna 50, the wireless section 52, the control section 54, the reception time detecting section 56, the timer 58 and the communication interface 60 of the ordinary base station 12 shown in FIG. 3, respectively.

Meanwhile, the control section 34 of the reference base station 11 differs from the ordinary base station 12 in respect of a time adjustment signal transmission control section 36 being functionally included. For the purpose of calculating a clock rate ratio and a time deviation between the timer 40 of the reference base station 11 and the timer 58 of each of the ordinary base stations 12, the time adjustment signal transmission control section 36 causes the wireless section 32 to transmit time adjustment signals representing signals for transmission from the reference base station 11 to the ordinary base stations 12. The time adjustment signal transmission control section 36 transmits the time adjustment signals in accordance with a predetermined sequence and a time interval, viz., in response to one of transmission of the position location signal from the mobile station 10 and transmission of the time adjustment signal from the reference base station 11 for execution of the other one of transmissions. More particularly, for instance, the transmission of the time adjustment signal is executed after an elapse of a 1^{st} predetermined time (first predetermined time) after the reference base station 11 has received the position location signal from the mobile station 10. Namely, after a first predetermined time adjustment code is transmitted, the operation stands ready for only a 2^{nd} predetermined interval (second predetermined interval) and, further, a second time adjustment code is transmitted.

FIG. 5 is a functional block diagram illustrating an essential part of the function of the position locating server 14 forming the mobile station position locating system 8 of the present embodiment. The position locating server 14 includes a so-called microcomputer comprised of, for instance, a CPU, a RAM, a ROM and input/output interfaces, etc. By performing signal processing in accordance with programs preliminarily stored in the ROM while utilizing a temporary storage function of the RAM, the CPU performs processing in a communication interface 64, a clock rate ratio calculating section 66, a time deviation calculating section 68, a reception time converting section 70 and a position locating section 72, etc. as described below.

The position locating server 14, connected to the respective base stations 11 and 12 via the cable 18, includes the communication interface 64, the clock rate ratio calculating section 66, the time deviation calculating section 68, the reception time converting section 70 and the position locating section 72, etc. Among these, the communication interface 64 allows the communication interfaces 42 and 60 of the base stations 11 and 12 connected through the cable 18 to perform required communications including: for instance, transmission and reception of measured data and transmission of commands for controlling the operations of the base stations 11 and 12 and the mobile station 10.

The clock rate ratio calculating section 66 calculates a clock rate ratio rera_sbnbi, representing a ratio of clock rates between the timer 58 of each of the ordinary base stations 12 and the timer 40 of the reference base station 11, based on: a reception interval between two spread codes, contained in the time adjustment signals detected by the respective reception time detecting section 56 of each of the ordinary base stations 12; and a reception interval between the two spread codes contained in the time adjustment signals generated by the time adjusting signal transmission control section 36 of the reference base station 11 and transmitted from the wireless section 32 or the like.

More particularly, the clock rate ratio rera_sbnbi is calculated based on tim_sb_trfend_sb and tim_sb_trlend_sb, representing transmission times in the reference base station 11, and tim_nbi_rvfend_sbnbi and tim_nbi_rvlend_sbnbi, representing reception times in the ordinary base stations 12, for the first and second time adjustment codes, respectively. These include the two spread codes contained in the time adjustment signals transmitted from the reference base station 11 to the ordinary base stations 12 and such calculation is executed as expressed by Equation (2):

$$rera\_sbnbi = \frac{tim\_nbi \_rvlend \_sbnbi - tim\_nbi \_rvfend \_sbnbi}{tim\_sb \_trlend \_sb - tim\_sb \_trfend \_sb} \qquad ( 2 )$$

In Equation (2), further, “i” represents the number for identifying the plurality of ordinary base stations 12 including three ordinary base stations 12A to 12C with the number being expressed as i=1˜3 in the present embodiment.

The time deviation calculating section 68 calculates a time deviation representing a time deviation between the time of the timer 58 of each of the ordinary base stations 12 and the time of the timer 40 of the reference base station 11. The time deviation, including a time advance or a time delay relative to the time of the timer 40 of the reference base station 11, is calculated based on, for instance: a transmission time at which the radio wave is transmitted from the reference base station 11; a reception time at which the ordinary base stations 12 receive the resulting radio wave; and a propagation time of the radio wave calculated based on a known distance between the reference base station 11 and the ordinary base station 12. This time deviation calculating section corresponds to time deviation calculating means.

More particularly, for instance, the time deviation te_aq_sbnbi is calculated based on Equation (3) expressed below using: the time tim_sb_trlend_sb representing transmission completion time at which completed transmission of the spread codes, transmitted from the wireless section 32 of the reference base station 11 to the ordinary base stations 12, is measured by the timer 40 of the reference base station 11; the reception completion time tim_nbi_rvlend_sbnbi at which the reception times of the spread codes in the ordinary base stations 12 are measured by the reception time detecting sections 56 upon using the timers 58 of the respective ordinary base stations 12; and the propagation time taus_i calculated in the system 8 by preliminarily dividing a distance (of, for instance, 30 m), already known, between the reference base station 11 and the ordinary base station 12 by a rate c (=2.997×10⁸ (m/s)) of the radio wave.

te_{—}aq_{—}sbnbi=(tim_{—}nbi_{—}rvlend_{—}sbnbi−tim_{—}sb_{—}trlend_{—}sb)−taus_{—}i (3)

With the present embodiment, for instance, the first and second time adjustment codes are used as the spread codes. A comparison is made between an apparent radio-wave propagation time, calculated based on a transmission completion time in the reference base station 11 and a reception completion time in the ordinary base station 12, and a real radio-wave propagation time calculated based on an actual distance between the reference base station 11 and the ordinary base station 12. If a difference exists between these values, such a difference represents the time deviation between the timer 40 of the reference base station 11 and the timer 58 of the ordinary base station 12.

The reception time converting section 70 corrects the reception time to the time of the timer 40 of the reference base station 11. The reception time is detected by the reception time detecting section 56 of each of the ordinary base stations 12 based on the timer 58 of each of the ordinary base stations 12 when the radio wave, transmitted from the mobile station 10, is detected by the respective ordinary base stations 12. Such correction is executed based on: the clock rate ratio between the timer 40 of the reference base station 11 and the timer 58 of each of the ordinary base stations 12 which is calculated by the clock rate ratio calculating section 66; and the time deviation between the timer 40 of the reference base station 11 and the timer 58 of each of the respective ordinary base stations 12 which is calculated by the time deviation calculating section 68.

More particularly, for instance, the reception time converting section 70 corrects the reception time in a sequence described below. First, suppose that the reception times, detected by the respective the reception time detecting sections 38 and 56 based on the timers 40 and 58 thereof when the radio wave, transmitted from the mobile station 10, is received by the reference base station 11 and the ordinary base stations 12, are expressed as tim_sb_rvend_m1sb for the reference base station 11 and tim_nb1_rvend_m1nbi for each base station 12i (i=1, 2, . . . ). In this instant, converting tim_nb1_rvend_m1nbi, representing the reception time detected by the reception time detecting section 56 of the ordinary base station 12i based on the timer 58 thereof, to the time based on the timer 40 of the reference base station 11 results in the reception time TOA_m1nbi of the ordinary base station 12i subsequent to the conversion as expressed by Equation (4) as:

$$TOA\_m 1 nbi = tim\_nbi \_rvend \_m 1 nbi - tim\_nbi \_rvfend \_sbnbi + taus\_i + ( tim\_sb \_trfend \_sb - tim\_sb \_rvend \_m 1 sb ) \times rera\_sbnbi + ( Δ tts + Δ trs ) \times rera\_sbnbi + tim\_sb \_rvend \_m 1 sb - Δ trs \qquad ( 4 )$$

Further, the reception time detecting section 38 of the reference base station 11 detects the reception time TOA_m1sb, based on the timer 40 of the reference base station 11, which is expressed by Equation (5):

TOA_{—}m1sb=tim_{—}sb_{—}rvend_{—}m1sb−Δtrs (5)

where Δtrs represents the reception delay time in the reference base station 11 and Δtts represents the transmission delay time in the reference base station 11. The transmission delay time represents the time between the beginning of transmission of the signal by the wireless section 32 of the reference base station 11 and actual emission of the signal as the radio wave in an air space. More particularly, this represents the time between a command being received from the control section 34 of the reference base station 11 and the radio wave being emitted from the antenna 30. This can be said to be a process time of the wireless section 32 that is placed between the control section 34 and the antenna 30. Meanwhile, the reception delay time represents the time at which the radio wave is emitted into air space from the reference base station 11 and, subsequently, the wireless section 32 detects reception of the resulting signal. In particular, this represents the time at which the reception signal is incident on the antenna 30 of the reference base station 11 and, subsequently, a microcomputer, i.e., the control section 34 or the reception time detecting section 38 detects the reception signal. Thus, this can be said to be the process time in the wireless section 32 that is placed between the antenna 30 and the control section 34 or the reception time detecting section 38. In addition, the reception delay time Δtri (i=1, 2, 3, . . . ) for the ordinary base station 12i and the transmission delay time Δttm for the mobile station 10 may be similarly defined.

The reception time converting section 70 corrects the reception time of the position location signal in the ordinary base station 12 to the time based on the timer 40 of the reference base station 11 for each of the ordinary base stations 12 in receipt of the position location signal transmitted from the mobile station 10 in such a way. Moreover, the clock rate ratio calculating section 66, the time deviation calculating section 68 and the reception time converting section 70 correspond to the reception time correcting section.

The position locating section 72 determines, e.g. calculates, a position of the mobile station 10 based on: the reception time of the position location signal in the ordinary base station 12 which is converted by the reception time converting section 70 to the time based on the timer 40 of the reference base station 11; the reception time of the position location signal in the reference base station 11; and information, etc., on positions of the base stations 11 and 12 that are preliminarily known.

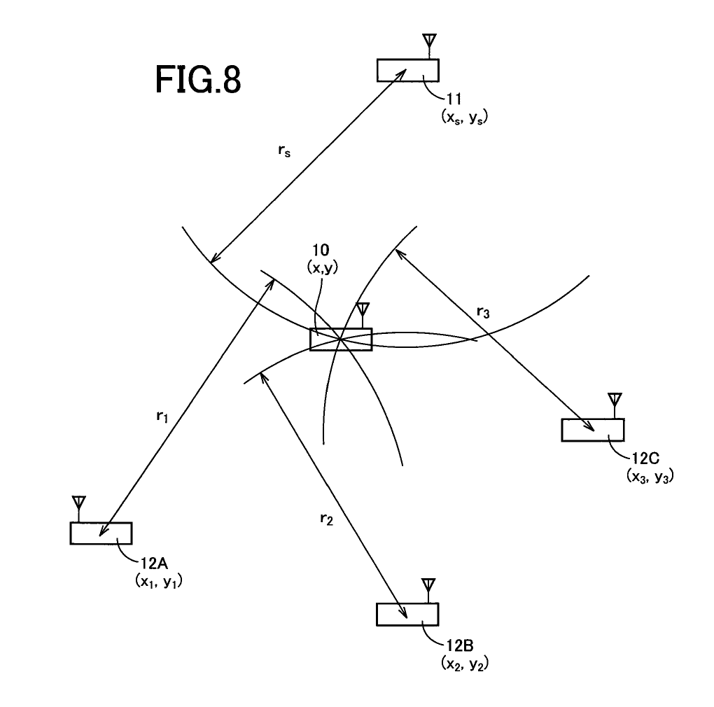

FIG. 8 is a view illustrating a principle of calculating the position of the mobile station 10 to be executed in the position locating section 72. Suppose that: a coordinate, representing the position of the mobile station 10, is indicated as (x, y); a coordinate, representing the position of the reference base station 11, is indicated as (xₛ, yₛ); a coordinate, representing the position of the first ordinary base station 12A, is indicated as (x₁, y₁); a coordinate, representing the position of the reference base station 12B, is indicated as (x₂, y₂); and a coordinate, representing the position of the reference base station 12C, is indicated as (x₃, y₃). These relationships are obtained by Equation (6) expressed below. In addition, the base stations 12, shown in FIG. 8, are placed different in layout from those of the base stations 12 shown in FIG. 1 for illustration purposes.

(xₛ−x)²+(yₛ−y)²={c×(Trₛ−Ts)}²

(x₁−x)²+(y₁−y)²={c×(Tr₁−Ts)}²

(x₂−x)²+(y₂−y)²={c×(Tr₂−Ts)}²

(x₃−x)²+(y₃−y)²={c×(Tr₃−Ts)}² (6)

where Trs, Tr1, Tr2 and Tr3 (sec) represent the reception times at which the position location signal is detected by the reception time detecting sections 38 or 56 of the reference base station 11, the first ordinary base station 12A, the second ordinary base station 12B and the third ordinary base station 12C, respectively; and Ts represents the transmission time at which the position location signal is transmitted from the wireless section 22 of the mobile station 10. That is, right sides of Equation (6) represent propagation distances of the radio wave in squares: obtained by multiplying propagation time of the radio wave between each of the reference base station 11, the first ordinary base station 12A, the second ordinary base station 12B and the third ordinary base station 12C and the mobile station 10 by a rate “c” of the radio wave. Equation (6) includes simultaneous equations with “x”, “y” and “z” being unknown. Eliminating Ts from Equation (6) yields Equation (7) expressed below.

\sqrt{(x₁−x)²+(y₁−y)²}−\sqrt{(xₛ−x)²+(yₛ−y)²}=c(Tr₁−Trₛ)

\sqrt{(x₂−x)²+(y₂−y)²}−\sqrt{(xₛ−x)²+(yₛ−y)²}=c(Tr₂−Trₛ)

\sqrt{(x₃−x)²+(y₃−y)²}−\sqrt{(xₛ−x)²+(yₛ−y)²}=c(Tr₃−Trₛ) (7)

In addition, taking a difference between a second formula and a first formula and a difference between a third formula and the first formula in Equation (7) yields the following Equation (8) as expressed below.

\sqrt{(x₂−x)²+(y₂−y)²}−\sqrt{(x₁−x)²+(y₁−y)²}=c(Tr₂−Tr₁)

\sqrt{(x₃−x)²+(y₃−y)²}−\sqrt{(x₁−x)²+(y₁−y)²}=c(Tr₃−Tr₁) (8)

Meanwhile, the reception time TOA_m1nbi of the position location signal in the ordinary base station 12, converted by the reception time converting section 70 to the time based on the timer 40 of the reference base station 11 as expressed by Equation (4) mentioned above, includes: reception delay time Airs in the reference base station 11 and the transmission delay time Δtts in the reference base station 11.

FIG. 7 shows how reception delay time Δtrs varies in terms of the time elapsed from the rising of the reference base station 11 and obtained on experimental tests conducted by the inventor of the subject patent application. As shown in FIG. 7, if about ten hours elapses from the rising of the reference base station 11, a value of reception delay time Δtrs varies by only about 11 seconds. When making an attempt to calculate a distance between the mobile station 10 and the base stations 11 and 12 based on propagation time of the radio wave, an error in propagation time appears as an error of the distance. Suppose that a speed of the radio wave is about 0.3 m/nsec, an error in propagation time of 11 nsec is equivalent to an error in distance of 3.3 m. Accordingly, it is considered that in detecting propagation time of the position location signal transmitted from the mobile station 10 and received by the base stations 11 and 12, taking account reception delay time results in a further increase in accuracy. Moreover, this similarly applies to transmission delay time.

A time difference of arrival (TDOA time difference of arrival) TDOA_m1_sbnbi between the reception times, at which the position location signal is sent from the mobile station 10 and received by the reference base station 11 and the ordinary base stations 12, is defined by Equation (9) expressed below.

$$\begin{matrix}TDOA\_m 1 \_sbnbi = TOA\_m 1 nbi - TOA\_m 1 sb \\ = ( tim\_nbi \_rvend \_m 1 nbi - \\ tim\_nbi \_rvfend \_sbnbi + taus\_i ) + \\ ( tim\_sb \_trfend \_sb - \\ tim\_sb \_rvend \_m 1 sb ) \times rera\_sbnbi + \\ ( Δ tts + Δ trs ) \times rera\_sbnbi\end{matrix} \qquad ( 9 )$$

Although reception delay time Δtrs and the transmission delay time Δtts of the reference base station 11 are contained in Equation (6) described above, none of these values can be detected in actual practice. Therefore, by acquiring a difference TDOA_m1_nb1nb2 between a time difference of arrival TDOA_m1_sbnb1 between the reception times, at which the position location signal, transmitted from the mobile station 10, is received by the reference base station 11 and the first base station 12A, respectively, and a time difference of arrival TDOA_m1_sbnb2 in the reception times of the reference base station 11 and the second base station 12B: Equation (10) is obtained as follows:

$$TDOA\_ml \_nb 1 nb 2 = TDOA\_m 1 \_sbnb 2 \_TDOA \_m 1 \_sbnb1 = TOA\_m 1 nb 2 - TOA\_m 1 nb 1 = tim\_nb 2 \_rvend \_m 1 nb 2 - tim\_nb 2 \_rvfend \_sbnb 2 + taus\_ 2 + ( tim\_sb \_trfend \_sb - tim\_sb \_rvend \_mlsb ) \times rera\_sbnb 2 - \{ \begin{matrix}\begin{matrix}tim\_nb 1 \_rvend \_m 1 nb 1 - \\ tim\_nb 1 \_rvfend \_sbnb 1 + taus\_ 1 +\end{matrix} \\ \begin{matrix}( tim\_sb \_trfend \_sb - tim\_sb \_rvend \_m 1 sb ) \times \\ rera\_sbnb 1\end{matrix} \end{matrix} \} \qquad ( 10 )$$

provided that:

(Δtts+Δtrs)×rera_sbnb1≅(Δtts+Δtrs)×rera_sbsnb2 (11)

This indicates that since a sum Δtrs+Δtts of reception delay time Δtrs and the transmission delay time Δtts in the reference base station 11 is extremely short as compared to the time such as the time difference of arrival or the like, the clock rate ratio rera_sbnbi between the ordinary base stations 12 and the reference base station 11 provides a minute influence.

Here, TOA_m1nb2−TOA_m1nb1 in Equation (10), described above, represents a difference between the reception time, at which the position location signal, transmitted from the mobile station 10, is received by the second ordinary base station 12B, and the reception time of the first ordinary base station 12A: and corresponds to (Tr2−Tr1) on a right side of a first formula in Equation (8) representing a value expressed in terms of the time of the timer 40 of the reference base station 11. Also, this represents a value obtained with reception delay time Δtrs and the transmission delay time Δtts being taken into account. TOA_m1nb3−TOA_m1nb1, similarly calculated, corresponds to (Tr3−Tr1) on a right side of a second formula in Equation (8) noted above.

Therefore, the position locating section 72 calculates the position of the mobile station 10 by solving “x” and “y” based on Equation (8) and Equation (10) mentioned above.

Turning back to FIG. 5, a determining section 74 determines if the transmission of the position location signal from the mobile station 10 and the reception of the time adjustment signal, transmitted from the reference base station 11 and received by the ordinary base stations 12, are executed within predetermined time that is determined in advance. In particular, the determining section 74 determines if the time between transmission time, at which the position location signal is transmitted from the position location signal transmission control section 26 of the mobile station 10, and the reception time, at which of the time adjustment signals transmitted from the time adjustment signal transmission control section 36 of the reference base station 11, the second time adjustment code is detected by the reception time detecting section 56 of the ordinary base station 12, lies in predetermined time that is determined in advance. This predetermined time is set up by a transmission time determining section 76, described below, and takes a value corresponding to position location accuracy which is realized by the mobile station position locating system 8. For at least one of the ordinary base stations 12, if the time between transmission time of the position location signal and the reception time of the second time adjustment code in the ordinary base station 12 does not fall in predetermined time, the answer of the determining section 74 is negative. This complies with a consequence with no position locating result of the mobile station position locating system 8 satisfying required position location accuracy.

The transmission time determining section 76 alters a value of the predetermined time based on position location accuracy of the mobile station, set up in, for instance, the mobile station position locating system 8 in advance or required for the mobile station position locating system 8 which is set up by an operator. Such alteration is determined such that predetermined time takes a maximum value to satisfy position location accuracy of the mobile station required for the mobile station position locating system 8: even if a time variation is likely to occur most rapidly in calculating the time variation between reception delay time and the transmission delay time of the base stations 11 and 12 as, for instance, the reference base station 11 calculates the time variation in reception delay time in FIG. 7. Such a maximum value of the predetermined time is determined, for a case in which the most rapid variation occurs in the reception delay time and the transmission delay time obtained for use in the base stations 11 and 12, by: calculating the relationship between position location accuracy of the mobile station, which the mobile station position locating system 8 can achieve, and the maximum value of the predetermined time in terms of the relationship such as mimetically formulae and maps obtained on preliminary experiments or simulations; calculating a value of the predetermined time, satisfying relevant accuracy, based on such relationship and mobile-station position location accuracy, set up for the mobile station position locating system 8; and setting up such a value to be predetermined time.

Further, a value of the second predetermined time represents a transmission interval between the first time adjustment code and the second time adjustment code in the reference base station 11. This value is used for the clock rate ratio calculating section 66 to calculate the clock rate ratio between the timer 40 of the reference base station 11 and the timer 58 of the ordinary base station 12. Therefore, such a value is determined not to fall below a minimum value required for maintaining accuracy of the clock rate ratio and preferably set to be a fixed value. Accordingly, the transmission time determining section 76 alters the predetermined time by altering a length of the first predetermined time corresponding to the time at which the reference base station 11 receives the position location signal and, subsequently, the first time adjustment signal is transmitted.

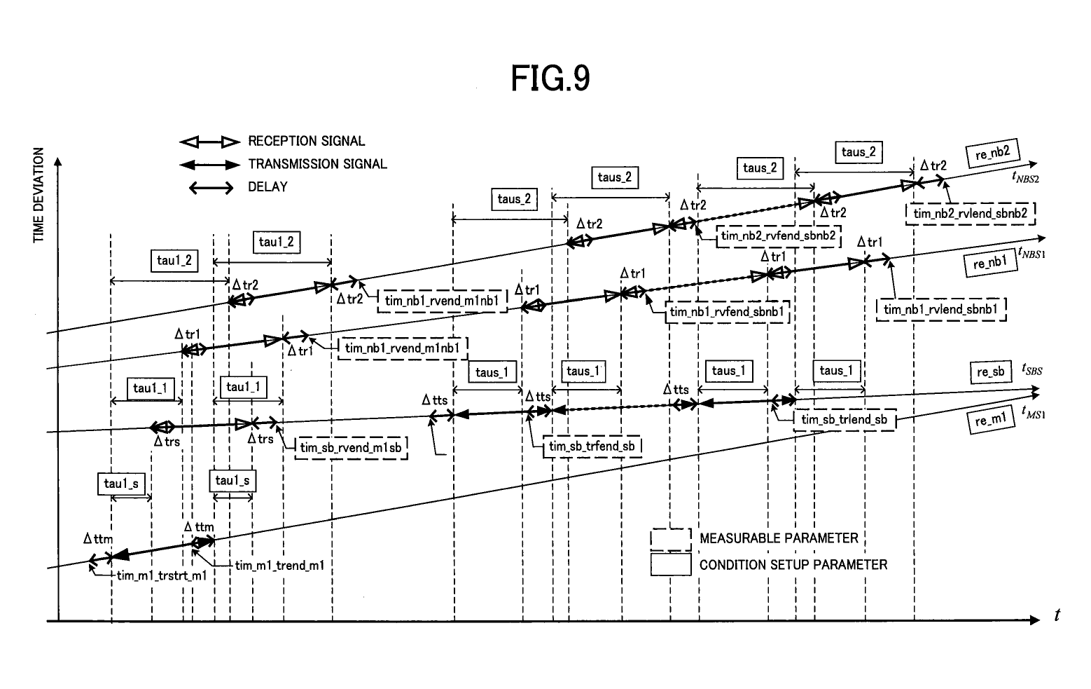

FIG. 9 represents a timeline diagram illustrating the relationship between the times on the basis of the timers of the mobile station 10, the reference base station 11 and the respective ordinary base stations 12. FIG. 9 exemplifies two ordinary base stations as examples including the first and second ordinary base stations 12A and 12B.

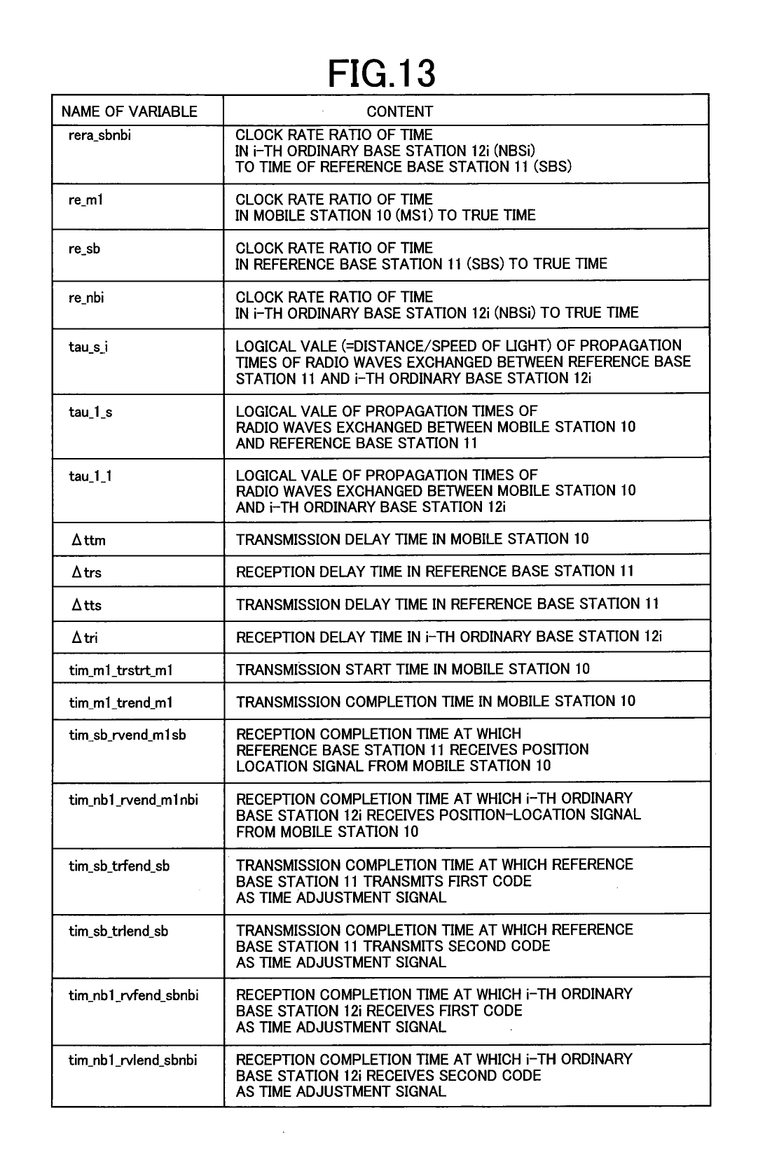

In FIG. 9, the abscissa axis represents the absolute time and the axis of ordinate represents a time deviation. The axes tMS1, tSBS, tNBS1 and tNBS2 represent the times based on the respective timers of the mobile station 10, the reference base station 11, the first ordinary base station 12A and the second ordinary base station 12B, respectively. This shows that the steeper the inclinations of these axes with respect to the abscissa axis become, the greater will be the clock rate ratio with respect to the absolute the time. Variables, surrounded in broken lines, represent variables that can be measured and variables, surrounded in solid lines, represent numerals that are preliminarily determined in the mobile station position locating system 8. In addition, arrowhead marks, ended with black-filled triangles, indicate that the radio wave is being transmitted during the times indicated by such arrows. Arrowhead marks, ended with whitened triangles, indicate that no radio wave is received during the times indicated by such arrows. Moreover, arrowhead marks, ended with angle bracket marks, represent reception delay time or transmission delay time. Moreover, definitions of respective variables in FIG. 9 are shown in FIG. 13. In FIG. 13, further, “i” represents a mark for identifying the ordinary base station. With the present embodiment, the ordinary base stations include the first to third ordinary base stations 12A to 12C in three pieces with expression of “i”=1, 2, 3.

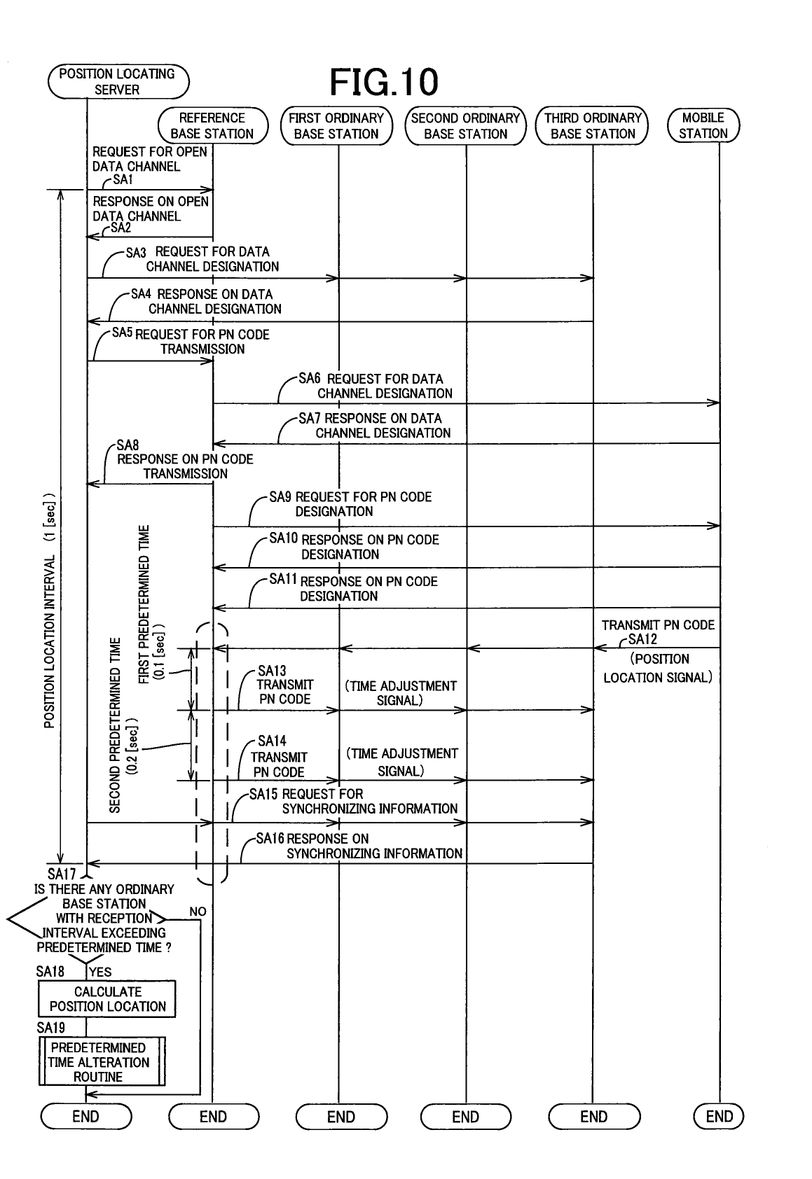

FIG. 10 is a timing chart illustrating one example of an outline of control operations executed in the mobile station position locating system 8 of the present embodiment and illustrates respective operations of the position locating server 14, the reference base station 11, the first to third ordinary base stations 12A to 12C and the mobile station 10. In FIG. 10, arrows in left and right directions indicate the occurrence of transmission and reception of information or transmission and reception of the radio waves in association with the directions of the arrows.

At SA1 to SA11, first, a position location signal and the time adjustment signals are set up for the position locating server 14, the reference base station 11, the first to third ordinary base stations 12A to 12C and the mobile station 10 for transmission and reception of the signals. Among these, at SA1, the position locating server 14 makes a request for open data channels to the reference base station 11 for retrieving the open data channels uninvolved in communication for ensuring frequencies (channel: CH) to perform wireless information communication among the reference base station 11, the first to third ordinary base stations 12A to 12C and the mobile station 10. At SA2 corresponding to such as the control section 34 and the wireless section 32 of the reference base station 11, the reference base station 11, received the request at SA1, retrieves the open channels in a known open data channel retrieving method by transmitting, for instance, an RTS (request to send) signal or the like. Succeedingly, the reference base station 11 provides an open data channel response to the position locating server 14 informing the open channels being found. In the present embodiment, the position locating server 14 and the reference base station 11 are connected to each other via communication cable 18. Thus, the position locating server 14 and the reference base station 11 may suffice to perform communication through such a cable 18.

At SA3 corresponding to such as the position locating section 72 of the position locating server 14, the position locating server 14 makes a data channel designation request to the reference base station 11 and the first to third ordinary base stations 12A to 12C for designating the open data channels, retrieved at SA1, as the data channels for performing data communication. At SA4 corresponding to such as the control section 34 and the wireless section 32 of the reference base station 11, and the control sections 54 and the wireless sections 52 of the ordinary base station 12, the open data channels, retrieved at SA1 as the data channels for performing data communications, are designated in the reference base station 11 and the first to third ordinary base stations 12A to 12C, respectively. In addition, the reference base station 11 and the first to third ordinary base stations 12A to 12C respectively provide data channel designation responses to the position locating server 14 indicating that designations have been completed. In the present embodiment, the position locating server 14 and the base stations 11 and 12 are connected to each other via communication cable 18 and, hence, the position locating server 14 and the base stations 11 and 12 may suffice to perform communication through such a cable 18.

At SA5 corresponding to such as the position locating section 72 of the position locating server 14, the position locating server 14 makes a PN code transmission request to the reference base station 11 for transmission and reception of the position location signal and the time adjustment signals. At SA6 corresponding to such as the control section 34 and the wireless section 32 of the reference base station 11, the reference base station 11, which has received such a request, makes a data channel designation request to the mobile station 10 for designating the frequency (of the data channel) for the position location signal to be transmitted from the mobile station 10. The data channels include, for instance, the channels of the reference base station 11 and the first to third ordinary base stations 12A to 12C respectively designated at SA3 for performing data communications. At SA7 corresponding to such as the wireless section 22 and the control section 24 of the mobile station 10, the channels, retrieved at SA5, are designated as the data channels for the mobile station 10 to transmit the position location signal: and the mobile station 10 makes the data channel designation response to the reference base station 11 indicating that the designation of the channels has been completed. Moreover, at SA8 corresponding to such as the control section 34 and the wireless section 32 of the reference base station 11, the reference base station 11 provides the PN code transmission response to the position locating server 14 informing that the designation of the channel for the position location signal to be transmitted from the mobile station 10 has been completed.

At SA9 corresponding to such as the control section 34 and the wireless section 32 of the reference base station 11, the reference base station 11 makes a PN code designation request to the mobile station 10 for designating the PN code as the position location signal. This designation request is made for designating which of the codes is to be transmitted as the position location signal when, for instance, the reception time detecting sections 38 and 56 of the base stations 11 and 12 and the position location signal transmission control section 26 of the mobile station 10 have plural PN codes in common.

At SA10 corresponding to such as the wireless section 22 and the control section 24 of the mobile station 10, the PN code, transmitted as the position location signal from the mobile station 10, is designated to that of the request made at SA9; and the mobile station 10 provides a PN code designation response to the reference base station 11 indicating that the designation of the channels has been completed. At SA 11, further, the PN code designation response, made at SA10, is repeatedly executed again. This is due to the fact that the mobile station 10 is arranged to transmit the position location signal (at SA12) in a moment described below in sequence subsequent to transmission of the PN code designation response described above; and, hence, the PN code designation response is repeatedly executed to enable the base stations 11 and 12 to surely receive the PN code designation response. But none of such repeated execution constitutes essential element.

At SA12 corresponding to such as the position location signal transmission control section 26, etc., of the mobile station 10, the position location signal is transmitted from the mobile station 10. The transmitted position location signal takes the form of the PN code whose request is made at SA9. In addition, this transmission is performed through the channel which is requested at SA6. Upon receipt of the position location signal being transmitted, further, the reception time detecting sections 38 and 56 of the base stations 11 and 12 detect the respective reception times.

SA13, corresponding to such as the time adjustment signal transmission control section 36 of the reference base station 11, is executed after an elapse of a first predetermined time, preliminarily designed to be, for instance, 0.1 (sec), upon receipt of the position location signal by the reference base station 11 at SA12. At SA13, of the time adjustment signals, the first the time adjustment code is transmitted through the channel to which request is made at SA3. Then, the reception time detecting sections 56 of the respective base stations 12 detect the respective reception times of the first time adjustment code.

SA14, corresponding to such as the time adjustment signal transmission control section 36, etc., of the reference base station 11, is executed after an elapse of the second predetermined time, preliminarily designed to be, for instance, 0.2 (sec), after the first time adjustment code is transmitted at SA13. At SA14, of the time adjustment signals, the second time adjustment code is transmitted through the channel to which request is made at SA3. Then, the reception time detecting section 56 of each of the base stations 12 detects the reception time of the second time adjustment code. Examples of the first and second time adjustment codes include, for instance, spread codes that are previously stored in the reference base station 11 and the ordinary base stations 12 in common.

At SA 15 corresponding to such as the position locating section 72, etc., of the position locating server 14, the position locating server 14 makes a synchronizing information request to the base stations 11 and 12, respectively, for sending information, required for the position of the mobile station to be located, to the position locating server 14. At SA16 corresponding to such as the control section 34 of the reference base station 11 and the control sections 54 of the ordinary base stations 12, further, the reference base station 11 and the ordinary base stations 12 respectively provide synchronizing information responses to the position locating server 14 for transmission of the information required to the position locating server 14. More particularly, the reference base station 11 transmits the reception times, at which the position location signal is received at SA12, respective transmission times of the first and second time adjustment codes, representing the time adjustment signals transmitted at SA13 and SA14, respectively, to the position locating server 14. Furthermore, the reception times, at which the position location signal is received at SA12, and the respective reception times at which the first and second time adjustment codes, representing the time adjustment signals received at SA13 and SA14, are transmitted from the ordinary base stations 12 to the position locating server 14.

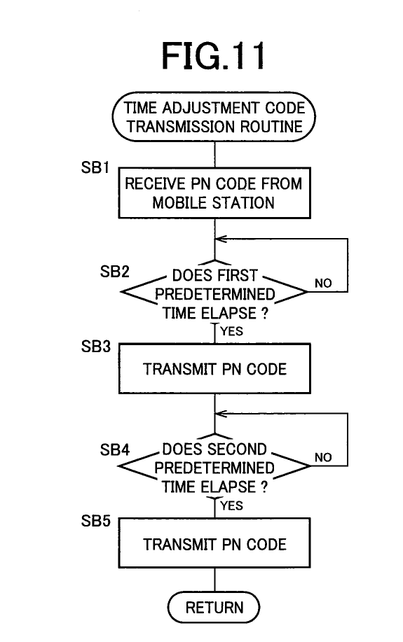

FIG. 11 represents a flowchart illustrating operation of the reference base station 11 related to the reception of the position location signal transmitted from the mobile station 10 and the transmission of the time adjustment signal for illustrating the sections encircled by the broken lines in the timing chart of FIG. 10 in further detail.

At step SB1 corresponding to such as the reception time detecting section 38 of the reference base station 11, first, the PN code, transmitted as the position location signal from the mobile station 10, is received and resulting the reception time is detected.

At step SB2 corresponding to such as the control section 34, etc., of the reference base station 11, a determination is made if the first predetermined time, determined in advance, has elapsed after the position location code has been received at SB1. If the first predetermined time, determined in advance, has elapsed after the position location code has been received at SB1, then, the answer to the current step is YES and SB3 is executed. If the first predetermined time, determined in advance, has not elapsed after the position location code has been received at SB1, then, the answer to the current step is NO and SB2 is repeatedly executed until the first predetermined time elapses.

At SB3 corresponding to such as the time adjustment signal transmission control section 36, etc., of the reference base station 11 and executed when the answer to SB2 is YES, the reference base station 11 transmits the PN code as the first time adjustment code for the time adjustment signal to the respective ordinary base stations 12.

At step SB4 corresponding to such as the control section 34, etc., of the reference base station 11, a determination is made if the second predetermined time, determined in advance, has elapsed after the first time adjustment code has been transmitted at SB3. If the second predetermined time, determined in advance, has elapsed after the first time adjustment code is transmitted at SB3, then, the answer to the current step is YES and SB5 is executed. If the second predetermined time, determined in advance, has not elapsed after the first time adjustment code is transmitted at SB3, then, the answer to the current step is NO and SB4 is repeatedly executed until the second predetermined time elapses.

At SB5 corresponding to such as the time adjustment signal transmission control section 36 or the like of the reference base station 11 and executed when the answer to SB4 is YES, the reference base station 11 transmits the PN code as the second time adjustment code of the time adjustment signal to the respective ordinary base stations 12.

Turning back to FIG. 10, at SA17 corresponding to the determining section 74 of the position locating server 14, a determination is made if the transmission of the position location signal at SA12 and the reception of the time adjustment signal by the ordinary base stations 12 at SA14 are executed within a predetermined time that is determined in advance. If any one of the ordinary base stations 12 is unsuccessful in transmission of the position location signal at SA12 and reception of the time adjustment signal at SA14 in the ordinary base stations 12 within the predetermined time determined in advance, the answer to the current step is NO. Then, the position location is stopped because of a difficulty of executing the position location to the extent satisfying position location accuracy required for the mobile station position locating system 8. In contrast, if all of the ordinary base stations 12 are successful in transmission of the position location signal at SA12 and reception of the time adjustment signal at SA14 in the ordinary base stations 12 within the predetermined time determined in advance, the answer to the current step is YES and SA18 is executed.

At SA18 corresponding to such as the clock rate ratio calculating section 66, the time deviation calculating section 68, the reception time converting section 70 and the position locating section 72, etc., of the position locating server 14, the calculation is executed for locating the position of the mobile station 10. That is, the clock rate ratio of the timer 58 of each ordinary base station 12 to the timer 40 of the reference base station 11 is calculated based on Equation (2) described above in response to information, transmitted from the base stations 11 and 12 to the position locating server 14 at SA16, which includes: the reception time at which the position location signal is received by the base stations 11 and 12 at SA12; the transmission times at which the first and second time adjustment codes, representing the time adjustment signals, are transmitted from the reference base station 11 at SA13 and SA14, respectively; and the reception times at which the first and second time adjustment codes, representing the time adjustment signals, are received by the respective ordinary base stations 12 at SA13 and SA14, respectively. Then, the time deviation between the timer 58 of each ordinary base station 12 and the timer 40 of the reference base station 11 is calculated based on Equation (3) described above. Subsequently, the reception time of the position location signal in each ordinary base station 12 is converted to the time of the timer 58 of the reference base station 11, based on Equation (4) described above, with the reception delay time and the transmission delay time in the reference base station 11 being taken into account. Succeedingly, Equations (8) and (10), resulting from the reception time of the position location signal in the ordinary base station 12 which is converted, the reception time of the position location signal in the reference base station 11 and information related to the positions of the base stations 11 and 12, are solved upon which calculation is executed, based on time differences of arrival (TDOA) of the position location signal in the base stations 11 and 12, for locating the position of the mobile station 10.

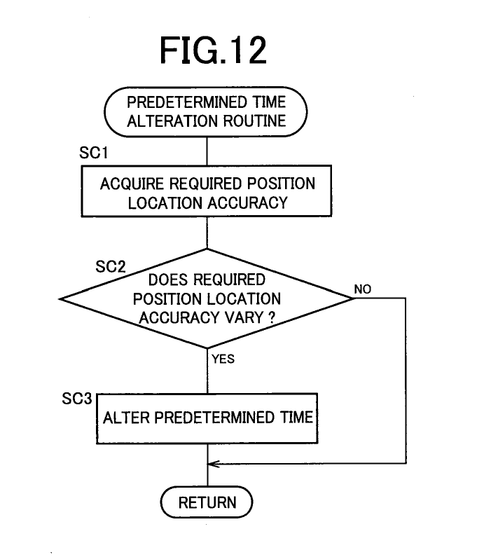

At SA19 corresponding to the transmission time determining section 76 of the position locating server 14, predetermined time alteration routine is executed for altering a value of the predetermined time. FIG. 12 is a flowchart illustrating such predetermined time alteration routine.

At SC1, first, a predetermined value for position location accuracy of the mobile station 10, required for the mobile station position locating system 8, is acquired. At SC2, a determination is made if the predetermined value for position location accuracy, acquired at SC1, varies from a preceding value, i.e., one that is used when, for instance, last position location is executed. If the acquired predetermined value for position location accuracy varies from the preceding one, then, the current step is YES and C3 is executed. This complies with a case or the like where an operator accepts an updated required value being input. In contrast, if no variation takes place between the obtained predetermined value for position location accuracy and the preceding one, the answer to the current step is NO and no SC3 is executed with the current routine being completed.

At SC3, a value for the predetermined time, corresponding to an updated setup value on position location accuracy altered at SC2, is determined. As described above, the value of such predetermined time is calculated in advance for a case in which the most rapid variation occurs in the reception delay time and the transmission delay time obtained for use in the base stations 11 and 12. Such a value is calculated based on the relationship between position location accuracy of the mobile station, which the mobile station position locating system 8 can achieve, and the maximum value of the predetermined time and mobile-station position location accuracy acquired at SC1.

With the embodiment set forth above, the mobile station position locating system 8 is comprised of the plural base stations 11 and 12 including: the reference base station 11, from which the predetermined spread codes are transmitted several times as the time adjustment signals; and the ordinary base stations 12 which receive the time adjustment signals transmitted from the reference base station 11. The clock rate ratio calculating section 66, the time deviation calculating section 68 and the reception time converting section 70 correct the reception time of the position location signal, calculated by each ordinary base station 12 based on the timer 58 thereof, to the time based on the timer 40 of the reference base station 11. Such calculation is executed based on: the clock rate ratio rera_sbnbi between a clock rate of the ordinary base station 12i(i=1, 2, . . . ) and a clock rate of the reference base station 11 which are calculated for each ordinary base station 12 based on a result in which the time adjustment signals are received by the ordinary base station 12 and a result in which the time adjustment signals are transmitted from the reference base station 11; the time deviation te_aq_sbnbi between the time of the timer 58 of the ordinary base station 12i and the time of the timer 40 of the reference base station 11 which are calculated for each ordinary base station 12; and the transmission delay time Δtts and the reception delay time Δtrs in the reference base station 11. The position locating section 72 calculates the position of the mobile station 10 based on: the reception times at which the position location signals are received by the ordinary base stations 12 and corrected by the reception time converting section 70; the reception time at which the position location signal is received by the reference base station 11; and positional information on the ordinary base stations 12 and the reference base station 11. Further, the mobile station 10 or the ordinary base stations 12 respond to one of transmission of the position location signal, executed by the mobile station 10, and transmission of the time adjustment signal, executed by the reference base station 11, for executing the other one of transmissions. Accordingly, calculation of the time deviation by the time deviation calculating section 68, calculation of the clock rate ratio by the clock rate ratio calculating section 66, and calculation of the position of the mobile station 10 are executed in steps in pair such that the position of the mobile station 10 can be calculated in conjunction with the calculated clock rate ratio and the time deviation.

With the mobile station position locating system 8 of the present embodiment, further, the mobile station 10 transmits the position location signal and the ordinary base stations 12 receive the time adjustment signals transmitted from the reference base station 11 at timing within predetermined time that is determined in advance. Under a circumstance where a variation takes place in values of transmission delay time or reception delay time in the base stations 11 and 12, it is likely that such a variation becomes mostly remarkable. Even under such a circumstance, the predetermined time can be preliminarily set up so as to allow the mobile station position locating system 8 to perform the position location within a required range of position location accuracy. This enables the reception time on the position location signal, calculated by the ordinary base station 12 based on the timer of the ordinary base station 12, to be corrected to the time based on the timer of the reference base station 11 in response to such as the clock rate ratio and the time deviation.

Further, the mobile station position locating system 8 of the present embodiment includes the determining section 74 for determining if the transmission of the position location signal from the mobile station 10 and the reception of the time adjustment signal, transmitted from the reference base station 11, in the ordinary base station 12 are executed within the predetermined time. Under a circumstance where the variation takes place in values of the transmission delay time or the reception delay time, it is likely that the mostly remarkable fluctuation takes place in transmission of the position location signal from the mobile station 10 and transmission of the time adjustment signals from the reference base station 11. Even under such a circumstance, a determination is made if the mobile station position locating system 8 has executed the position location within predetermined time, set up in advance, to allow the mobile station position locating system 8 to perform the position location within a required range of position location accuracy. By making such a determination, the reception time of the position location signal, calculated by the ordinary base station 12 based on the timer 58 thereof, can be corrected to the time based on the timer 40 of the reference base station 11. Thus, a determination can be made if the position of the mobile station to be located within the required range of position location accuracy.

Furthermore, the mobile station position locating system 8 of the present embodiment includes the transmission time determining section 76 for determining the predetermined time based on position location accuracy required for the position locating section 72 to calculate the position of the mobile station 10. Thus, even if the variation takes place in values of the transmission delay time or the reception delay time, the predetermined time can be preliminarily set up so as to satisfy position location accuracy required for the position locating section 72 to calculate the position of the mobile station 10.

While the present invention has been described above in detail with reference to the embodiment shown in the accompanying drawings, the present invention may be implemented in other modes.

For instance, the correlation value, used for the embodiment described above for detecting the reception time, is not limited to a value defined in Equation (1) and may depend on other definitions. Examples may include those which can detect synchronization between the replica code and the received signal in terms of a peak value.

In the embodiment described above, moreover, the ordinary base stations 12 and the reference base station 11 include those shown in FIGS. 3 and 4, respectively, and are made different from each other in respect of the time adjustment signal transmission control section 36. However, the reference base station 11 may be arranged in structure to play a role as the ordinary base station 12.

In the embodiment described above, besides, the position location signal is transmitted from the mobile station 10 and received by the reference base station 11 and the ordinary base stations 12, respectively. However, the present invention is not limited to such a mode. That is, an arrangement may be such that position location signals are transmitted from the base stations 11 and 12 to the mobile station 10 in sequence, respectively.

In the embodiment described above, further, as shown in the timing chart shown in FIG. 10, although the time adjustment signal is transmitted from the reference base station 11 after the position location signal is transmitted from the mobile station 10, the present invention is not limited to such a mode. That is, an arrangement may be such that after the time adjustment signals are transmitted from the reference base station 11, for instance, the reference base station 11 makes a transmission request to the mobile station 10 which in turn transmits the position location signal.

In the embodiment described above, furthermore, although the reference base station 11 is arranged to receive the command from the position locating server 14 and make response to such a command, the present invention is not limited to such a mode and the other ordinary base stations 12 may be arranged to perform such tasks.

In the embodiment described above, moreover, although the base stations 11 and 12 and the position locating server 14 are connected to each other via communication cable 18 to perform information communication, the present invention is not limited to such a connection. For instance, a wireless communicating function like, for instance, a wireless LAN may be employed. In this case, the communication interfaces 60, 42 and 64 may suffice to have communicating functions depending on a kind of communications.

In the embodiment described above, besides, although the reference base station 11 employs the retrieving RTS signal for the open channel at SA2 in FIG. 10, the present invention is not limited to such a signal and the open channel may be retrieved in other known methods.

In the embodiment described above, further, although the PN code, transmitted as the position location signal, is selected from the codes of multiple kinds that are preliminarily stored in the base stations 11 and 12 and the mobile station 10 in common, the present invention is not limited to such a mode and a preliminarily determined code of one kind may be used at all the times. In addition, although the PN codes, transmitted as the first and second time adjustment codes of the time adjustment signals, include the codes that are preliminarily determined in the base stations 11 and 12, it may suffice to use one code selected from codes of multiple kinds stored in common.

In the embodiment described above, furthermore, although the time adjustment signals, transmitted from the reference base station 11, include the first and second time adjustment codes, the present invention is not limited to such codes and examples of the codes may include three or more codes in combination.

What is claimed is:

1. A mobile station position locating system comprising:
a mobile station configured to transmit a position location signal; and
a plurality of base stations configured to receive the position location signal transmitted from the mobile station, wherein:
the plurality of base stations comprises:
a reference base station configured to transmit predetermined spread codes several times as time adjustment signals; and
an ordinary base station configured to receive the time adjustment signals transmitted from the reference base station; and
the mobile station position locating system comprising:
a reception time correcting section configured to correct a reception time of the position location signal, determined by the ordinary base station based on a timer thereof, to a time based on a timer of the reference base station in response to: a clock rate ratio between a clock rate of the ordinary base station, determined for each of the ordinary base station based on a result in which the time adjustment signals are received by the ordinary base station and a result in which the time adjustment signals are transmitted from the reference base station, and a clock rate of the reference base station; a time deviation between the time of the timer of the ordinary base station, determined for each of the ordinary base station, and the time of the timer of the reference base station; and a transmission delay time and a reception delay time in the reference base station; and
a position locating section configured to determine a position of the mobile station based on: the reception time of the position location signal in the ordinary base station which is corrected by the reception time correcting section; the reception time of the position location signal in the reference base station; and positional information on the ordinary base station and the reference base station; and
the mobile station and the reference base station are configured to be responsive to one of transmission of the position location signal from the mobile station and transmission of the time adjustment signal from the reference base station for executing the other one of the transmissions.

2. The mobile station position locating system according to claim 1, wherein:
the transmission of the position location signal from the mobile station and the reception of the time adjustment signal, transmitted from the reference base station, in the ordinary base station are executed within a predetermined time.

3. The mobile station position locating system according to claim 1, further comprising:
a determining section configured to determine whether the transmission of the position location signal from the mobile station and the reception of the time adjustment signal, transmitted from the reference base station, in the ordinary base station are executed within a predetermined time.

4. The mobile station position locating system according to claim 2, further comprising:
a transmission time determining section configured to determine the predetermined time based on position location accuracy required for the position locating section to determine the position of the mobile station.
